(19) United States
(12) Patent Application Publication
(10) Pub. No.: US 2016/0314616 A1
(43) Pub. Date: Oct. 27, 2016

(54) 3D IDENTIFICATION SYSTEM WITH FACIAL FORECAST

(71) Applicant: Sungwook Su, Torrance, CA (US)

(72) Inventor: Sungwook Su, Torrance, CA (US)

(21) Appl. No.: 15/135,536

(22) Filed: Apr. 21, 2016

Related U.S. Application Data
(60) Provisional application No. 62/151,897, filed on Apr. 23, 2015.
(60) Provisional application No. 62/216,916, filed on Sep. 10, 2015.

(51) Int. Cl. G06T 17/00; G06T 7/40; H04N 5/247; G06T 15/30; G06T 7/60; G06F 3/0484; G06T 7/00; G06T 19/20

(52) U.S. Cl. CPC G06T 17/00; G06T 7/0051; G06T 7/408; G06T 19/20; G06T 15/30; G06T 7/608; G06F 3/04845; H04N 5/247; G06T 2207/30196; G06T 2207/10008; G06T 2219/2021

(57) ABSTRACT

Some embodiments provide a system for reconstructing an object from scanned data. In reconstructing, the system captures a visual representation and a volumetric representation. The visual representation is captured to reconstruct the object, while the volumetric representation is captured to identify the object from a group of other objects. In some embodiments, the object is a human being, and the visual and volumetric representations are used for a full facial dimension (FFD) identification system (FFDIS).

### CLAIM OF BENEFIT TO PRIOR APPLICATIONS

This application claims the benefit of U.S. Provisional Patent Application 62/151,897, filed on Apr. 23, 2015. This application also claims the benefit of U.S. Provisional Patent Application 62/216,916, filed on Sep. 10, 2015. U.S. Provisional Patent Applications 62/151,897 and 62/216,916 are incorporated herein by reference.

### BACKGROUND

Today, many people use their digital cameras to take photos. A photo typically includes an object in a scene. Unless the photo is a 3D photo, the object is usually presented in 2D.

With the advent of technology, it is becoming more common to capture 3D representations of different objects. For instance, today, a person can use a 3D scanner to scan an object to capture 3D data. Also, some movie studios use a green screen and multiple cameras at different angles to capture 3D data. In addition, some people are now even experimenting with capturing 3D data with their mobile devices, such as a smart phone or tablet.

There are several problems with 3D data. The data may be large, which can make it difficult to process (e.g., render) and store. Also, the data might not be able to be used to reconstruct an object. For instance, depending on the scanning method, the data may include noise data. Further, the data might be incomplete because the entire object has not been scanned.

### BRIEF SUMMARY

Embodiments described herein provide a method of reconstructing an object from scanned data. In reconstructing, the method of some embodiments captures a visual representation and a volumetric representation. The visual representation is captured to reconstruct the object, while the volumetric representation is captured to identify the object from a group of other objects. In some embodiments, the object is a human being, and the visual and volumetric representations are used for a full facial dimension (FFD) identification system (FFDIS).

In capturing a visual representation from the scanned data, the method of some embodiments receives captured data of a scene that includes the object. The method then analyzes the data to detect the object in the scene. From a number of different types of 3D base models, the method selects a particular type of base model in accord with the detected object. The base model of some embodiments is a template with pre-assigned values relating to a specific type of object. After selecting the base model, the method deforms the base model to produce a visual representation of the object. Instead of using a base model, the method of some embodiments produces a new 3D model.

In some embodiments, the method captures a visual representation that is portable. By portable, the visual representation is optimized to be transferred over a network, such as the Internet. In some embodiments, the method processes many polygons to generate a 3D model having fewer polygons. For instance, the method may process an abundance of point data (e.g., thousands or even millions of point data) to produce a 3D model that has a uniform set of point data.

In some embodiments, the method provides a set of tools to modify a 3D model of an object. The method of some embodiments provides tools to forecast or predict how a person may appear at a give age. For instance, the method may be used to make a person appear younger or older. This can be for a person's face, the entire head, the body, etc. The method of some embodiments provides other tools to change the appearance of an object. For instance, the method may be used change the weight of a person, forecast weight changes, etc.

In some embodiments, the method captures a volumetric representation of an object from scanned data. The method of some embodiments reads the scanned data of the object to compute its volume data. In some embodiments, the volume data is represented in 3D graphic unit (e.g., voxel). The scan data may come with depth data. The depth data may include position data, photo image data, (e.g., maps, photos). In some embodiments, the method treats such depth data as a volume data instead of shape data. That is, the method produces a volumetric representation by processing the depth data associated with the scanned data.

In capturing, the method of some embodiment captures multiple volumetric datasets (i.e., sets of volumetric data) having different resolutions. This is because comparing 3D models can take an extended period of time to process. By taking the different resolutions of voxel data, the method performs a multi-level comparison in order to find a matching object. For instance, the method can perform a first level search for one or more matching low resolution voxel data sets. Thereafter, the method can perform a second level search for a matching higher resolution data set. Different embodiments can have different number of levels (e.g., two, three, etc.).

Some embodiments provide a system. The system has a capturing device having a set of cameras and a set of sensors to capture a 3D representation of an object. The system has a computing device having a processor and a storage storing a program that when executed by the processor processes the 3D representation to produce a visual representation and a volumetric representation of the object. In some embodiments, the visual representation is captured to present the object, and the volumetric representation is captured to identify the object from a group of other objects.

In some embodiments, the object is a person, and the visual and volumetric representations are used to identify the person. In some embodiments, the 3D representation has several (e.g., many) polygons, and the program processes the polygons to produce a visual representation that has a fewer number of polygons.

Some embodiments provide a method of presenting a representation of at a given time period. For instance, the method can be used to predict how a person will appear or would have appeared using a 3D model. The method of some embodiments creates a first model of an object in a first time period. The method creates a second model of the object in a second time period. The method computes the changes in feature of the first and second models. The method generates, based on the changes, a third model of the object in a third time period.

Embodiments described herein also provide a system that performs FFDI. The system of some embodiments includes a capturing device having a set of cameras and a set of sensor to capture a 3D representation of an object. The system also has a computing device having a processor and a storage storing a program that when executed by the processor processes the 3D representation to produce a volumetric representation of the object. In some embodiments, the volumetric representation includes multiple sets of volume data at different resolutions, and the multiple sets of volume data are used to perform a multi-level search for the same object.

The preceding Summary is intended to serve as a brief introduction to some embodiments as described herein. It is not meant to be an introduction or overview of all subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purposes of explanation, several embodiments of the invention are set forth in the following figures.

FIG. 1 provides an illustrative example of rebuilding a 3D model from an object that is represented in captured data.

FIG. 2 conceptually illustrates a process that some embodiments implement to create a 3D model of an object.

FIG. 3 shows an example of building a new 3D model from captured data of an object.

FIG. 4 shows an example of extracting and saving several maps when dynamically generating a new 3D model.

FIG. 5 conceptually illustrates an example process that some embodiments perform to create a 3D model of an object.

FIG. 6 provides an illustrative example of filtering captured data to remove unwanted data.

FIG. 7 provides an illustrative example of reconstructing an incomplete object.

FIG. 8 conceptually illustrates an example of combining images from several devices to produce a 3D model.

FIG. 9 shows an example of using a normal map to generate a high-poly model from a low-poly model.

FIG. 10 shows an example modifying facial features of a person using a 3D model.

FIG. 11 conceptually illustrates operations performed by the system of some embodiments to predict and show how a person will appear at a given age.

FIG. 12 conceptually illustrates an example process that some embodiments perform to predict how an animate object will appear at a given age.

FIG. 13 shows an example of creating volume data from scanned data of an object.

FIG. 14 shows an example of using volume data to generate a group of voxels.

FIG. 15 shows an example of a multi-level volumetric search to identify an object.

FIG. 16 illustrates an example system that captures and presents 3D models.

FIG. 17 conceptually illustrates a computer system with which some embodiments of the invention are implemented.

FIG. 18 conceptually illustrates the computer system of FIG. 17.

FIG. 19 conceptually illustrates a computer system with which some embodiments of the invention are implemented.

FIG. 20 conceptually illustrates a mobile device with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a system for reconstructing an object that is represented in scanned data. The system receives captured data of a scene that includes the object. The system then analyzes the data to detect the object in the scene. From a number of different base models, the system selects a particular type of base model in accord with the detected object. The base model of some embodiments is a template with pre-assigned values relating to a specific type of object. After selecting the base model, the system deforms the base model to produce a representation of the object. In some embodiments, the representation is a 3D model of the object that can be cataloged, searched, and/or modified.

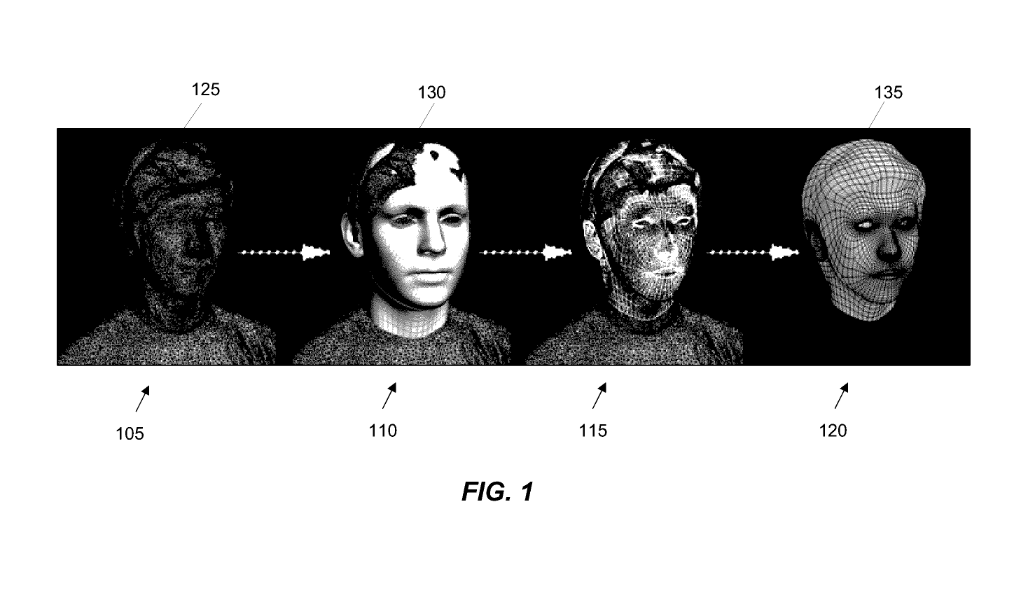

In some embodiments, the system includes a program for reconstructing objects. FIG. 1 conceptually illustrates operations performed by such a program to create a 3D model. In particular, the figure shows the program producing a 3D model 135 by deforming a base model 130 using captured data 125. In the illustrated example, the object is a person's entire head, including the neck. However, the object can be any animate or inanimate object. For instance, the object can be a person (e.g., entire body), a part of the person (e.g., the person's face, body part, organ, etc.), an animal, a place, a thing, etc.

Four operational stages 105-120 of the program are illustrated in FIG. 1. These stages will be described in detail below after an introducing of several elements shown in the figure. In some embodiments, the program initially receives captured data 125. The data may originate from one or more different data sources. The data might have been captured with a set of one or more cameras. As an example, multiple cameras might have been used to capture the person's head from different angles. The data might have been captured using a 3D scanner. The data might have been captured with a computing device having a depth sensor and a camera. Examples of different computing device include a computer (e.g., laptop, desktop), gaming system, and mobile device (e.g., phone, tablet). The data might have been captured with an input device that is communicatively coupled or connected to a computing device. An example of such an input device is Kinect® by Microsoft.

Irrespective of the capture method, the data 125 has a set of field values that the reconstruction tool uses to modify the base model. The data may include a number (e.g., millions) of vertex counts or point data. The data may include one or more maps (e.g., images) that define the color, texture, the height (i.e., surface elevation), and/or the angular surface details of the object. For instance, the data may include a color map that defines the various colors of an object in the scene. Alternatively or conjunctive with the color map, the data may include a normal map, which is an image used to provide additional 3D detail to a surface by changing the shading of pixels so that the surface appears angular rather than completely flat. The normal map or some other map (e.g., a heightmap) can also be used to define height. Different embodiments can use different maps. For instance, the system may use a bump map to define the bumps on the surface of the object.

Depending on the capture method, the captured data may include useless noise data. The captured data may include noise data or artifacts for several different reasons. As a first example, the object and/or the sensor may have been in motion when it was captured with a particular device. As a second example, the ambient light of the scene may have affected how the object was captured. As will be described in detail below, the reconstruction program of some embodiments automatically filters out the noise when generating a 3D model.

The base model 130 of some embodiments is a template with pre-assigned values. Specifically, the base model template includes pre-assigned values relating to a specific type of object. The template may include a set of field values for each of the different features of the object. For instance, if the object is a human head, the base model template may have pre-defined values relating to facial features, such as the eyes, nose, mouth, etc. In some embodiments, the base model is a polygon mesh that is defined by vertices, edges, and faces. A vertex is a special type of point that describes a corner or intersection of a shape or object. An edge represents two vertices that are connected to one another. A face represents a set of edges that are joined together to form a surface.

There are several reasons why the program, in some embodiments, uses a base model 130 when capturing an object. First, the program does not have to dynamically generate a new model. This can save time because, for certain objects, generating a new model is a processor and/or memory intensive task. The base model is associated with a uniform set of items that define the object. In some embodiments, the resulting model has the same vertex count and UV data (i.e., texture coordinates) as the original base model. The specific values may change from one resulting model to another. However, each resulting model is uniformly associated with the same number of data fields. The uniformity of the base model also allows the same type of object to be easily stored, cataloged, searched, and/or modified. In some embodiments, the base model is defined by a uniform set of polygons having a grid shape.

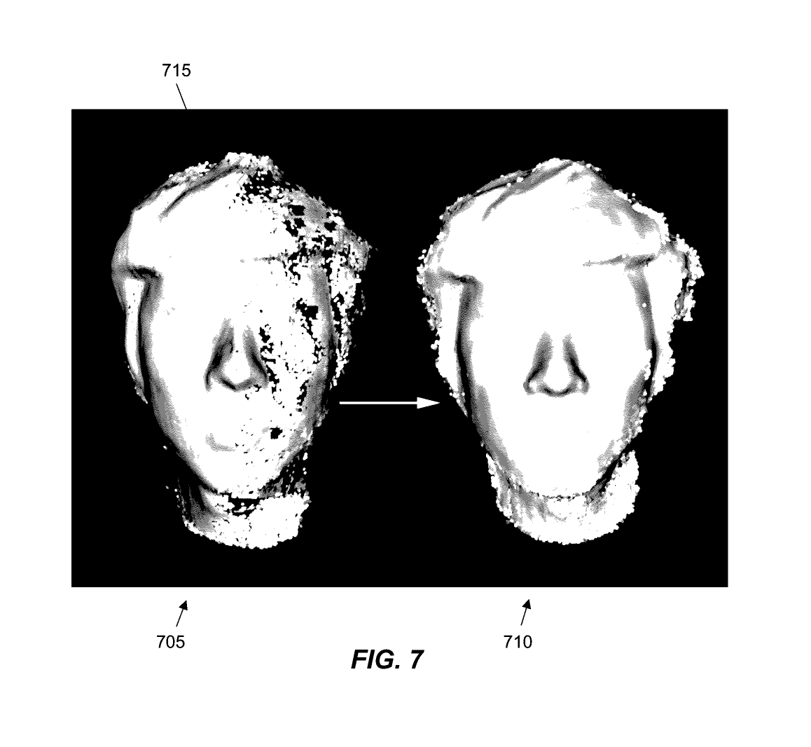

Second, the resulting model provides more detail in un-scanned areas. As an example, the captured data of a human head may not include data relating to specific areas such as inside the mouth, behind the ears, etc. In such areas, the program may use the base model's default values, modify those values to present the object. In other words, the program of some embodiments fills in the details that are not specified in the captured data. The end result is a 3D model that appears on screen with less visual artifacts than one with missing data. Several examples of reconstructing objects will be described below by reference to FIG. 7.

Similar to the captured data, the resulting model of some embodiments is associated with one or more maps or images that define the color, texture, the height (i.e., surface elevation), and/or the angular details of the object. For instance, the resulting model may be associated with a color map, a normal map, and/or some other map. The system of some embodiments retains one or more of the maps associated with the captured data in order to present the object.

Having described several elements, the operations of the program will now be described by reference to the four stages 105-120 that are shown in FIG. 1. The first stage 105 shows that the program has received the captured data 125. The captured data may be raw data (i.e., unprocessed data) from one of the data sources enumerated above (e.g., a 3D scanner, a device with camera and depth sensor, etc). In the first stage 105, the program has also loaded the data for processing.

In the second stage 110, the program has analyzed the data 125. The analysis has resulted in the program detecting a human head. Based on the result, the program has selected a base model 130 for a human head. In some embodiments, the program selects the same base model for a particular type of object. For instance, the program of some embodiments selects one base model for all human head, regardless of the person's gender, size, etc.

In some embodiments, the program identifies an object in a scene based on the shape of the object and/or the features associated with the object. For instance, in detecting a human head, the program may search for a shape that resembles a human head. The program may then attempt to identify one or more features or characteristics associated with the human head such as the eyes, nose, lips, etc. In detecting, the program may also try to identify the position of those features on the shape.

The second stage 110 of FIG. 1 shows that the program takes the base model 130 and deforms the model in accord with the captured data 125. In particular, the program associates values in the captured data with that of the base model. Based on the association, the program then alters the base model so that the model's values reflect that of the captured data. In the example of the second stage 110, the program alters the properties (e.g., vertices, edges, faces) of the polygon mesh. This is shown with raw data being applied to a portion of the forehead of the base mode.

As mentioned above, the capture data may include a number (e.g., millions) of vertex counts or point data. In some embodiments, the program filters out the noise and uses filtered low polygonal template model (e.g., the base model 130) to reduce the number of vertex counts and size, but not to reduce the level of detail. Each time the system transfers the captured data into template model, the program extracts or bakes out the surface height details into the normal map as a texture that contain displacement information. In some embodiments, the program extracts color and/or texture information relating to the different surfaces. So each time the system generates a 3D object, the program may compute or extract mesh data (e.g., vertices, edges, faces), and extract the color map and the normal map (e.g., heightmap) from the captured data.

In some embodiments, the program identifies a proper position on the model to apply the captured data. The program might use a 2D photo image that is taken together with depth data. The program then might (1) analyze the face in the photo, (2) identify properties of the face, (3) transfer those properties to 3D space, and (4) align transferred properties with those of the 3D model. As an example, once the program detects a known shape, the program associates pieces of data from the captured data set with that of the base model. The program moves the vertex into scanned data so that the resulting 3D model has the same volume and shape as the object in the scene. In moving, the program may adjust the vertices associated with the base model in accordance with the vertices associated with the object in the captured data.

In the third stage 115 of FIG. 1, the program continues to apply the captured data 125 to the base model 130. The fourth stage 120 shows the resulting 3D model 135 that the program has generated from the captured data. The resulting 3D model retains much of the details of the target object. As indicated above, the captured data 125 may include an abundance of point data (e.g., thousands or even millions of point data). Different from the captured data, the resulting 3D model 135 has a uniform set of point data.

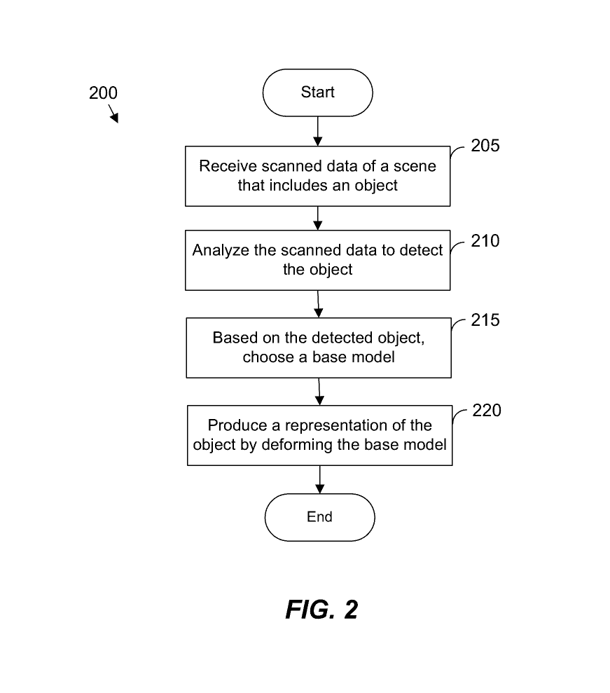

Having described a system, a process will now be described. FIG. 2 conceptually illustrates an example a process 200 that some embodiments implement to create a 3D model of an object. In some embodiments, the process 200 is performed by a reconstruction program that executes on a computing device.

As shown in FIG. 2, the process 200 begins by receiving (at 205) scanned data of a scene that includes the object. The process 200 then analyzes (at 210) the data to detect the object in the scene. Based on the detected object, the process 200 chooses (at 215) a base model. For instance, the process 200 might choose one specific base model from a number of different base models in accord with the detected object. The process 200 then deforms (at 220) the base model to produce a representation of the object. The process 200 then ends.

Some embodiments perform variations on the process 200. The specific operations of the process 200 may not be performed in the exact order shown and described. The specific operations may not be performed in one continuous series of operations, and different specific operations may be performed in different embodiments.

Several additional examples of generating 3D models are described below. Specifically, Section I describes, instead of using a base model, dynamically generating a new 3D model based on a detected object . . . . Section II then describes several example operations performed by the system to construct a 3D model. This is followed by Section III that describes a 3D volumetric identification system. Lastly, Section IV describes several electronic systems for implementing some embodiments of the invention.

### I. Dynamically Generating a 3D Model

In several of the examples described above, the system uses a pre-defined base model to replicate an object. Rather than using a base model, the system of some embodiments dynamically generate a new 3D model.

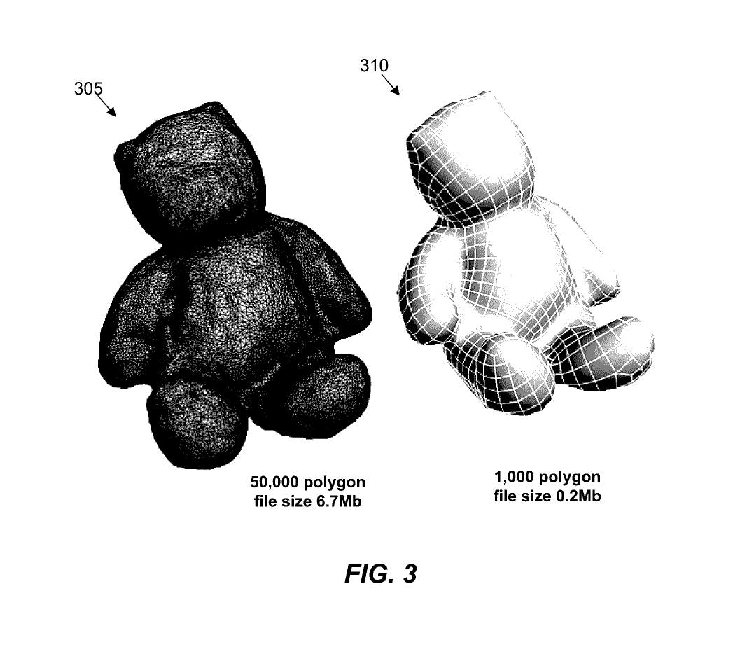

FIG. 3 shows an example of building a new 3D model from captured data of an object. Specifically, the figure shows that, for an unknown target, the system builds a polygon model 310 on the fly from captured data 305. In some embodiments, the 3D model is a normalized version of the captured data. This is because the system reduces the captured data to its canonical form. That is, the system reduces the abundant number of data points to a pre-defined number.

In the example of FIG. 3, the system loads the captured data of an object 305. The captured data has a high poly count, namely 50,000. The file size of the captured data is shown as 6.7 megabytes (Mb). After loading, the system iterates through the captured data 305 to generate a new model 310. The new model has a fixed set of poly count, namely 1,000. The file size has also been reduced from 6.7 Mb to 0.2 Mb. In essence, the system has generated a compressed representation of the captured data. Despite the compression, the representation retains much of the shape or form (e.g., curvature) of the object specified in the captured data. To retain the shape, the system of some embodiments iterates through a non-uniform set of polygons to create an object that has a uniform set of polygons having a grid shape.

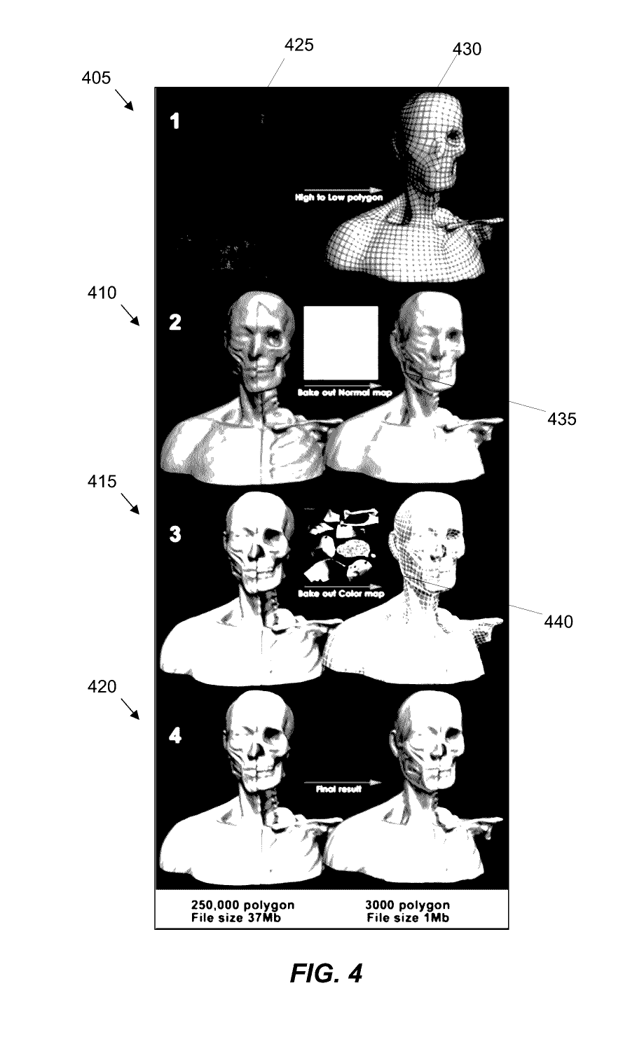

As mentioned above, the resulting model of some embodiments is associated with one or more maps or images that define the color, texture, the height (i.e., surface elevation), and/or the angular details of the object. In some embodiments, the system retains one or more of such maps in order to present the object. FIG. 4 conceptually illustrates a program that extracts and retains several maps when dynamically generating a new 3D model. Four operational stages 405-420 of the program are shown in the figure. The figure shows the captured object 425 and the 3D model 430.

In the first stage 405, the program generates a low-poly model 430 from a high-poly object 425. As shown, the captured object 425 has a high poly count, namely 250,000. The file size of the captured object is shown as 6.7 megabytes (Mb). By contrast, the new model 430 has a fixed set of poly count, namely 3,000. The file size has also been reduced from 37 Mb to 1 Mb.

The second stage 410 illustrates the program extracting a normal map 435 from the captured object 425. The second stage 410 also shows how the new 3D model 430 appears with the normal map in comparison to the captured object 425. With the normal map, the 3D model 430 appears with surface detail, which is different from the wire frame 3D model of the first stage 410.

The third stage 415 illustrates the program baking or extracting out a color map from the captured object 425. The third stage 415 also shows how the new 3D model 430 appears with the color map in comparison to the captured object 425. Lastly, the fourth stage 420 shows how the resulting 3D model 430 appears with all the maps in comparison to the captured object 425. In particular, the fourth stage 420 shows that the new 3D model 430 appears with surface detail and color, and is nearly identical to the captured object 425 despite its reduced number of polygons.

### II. System Operations

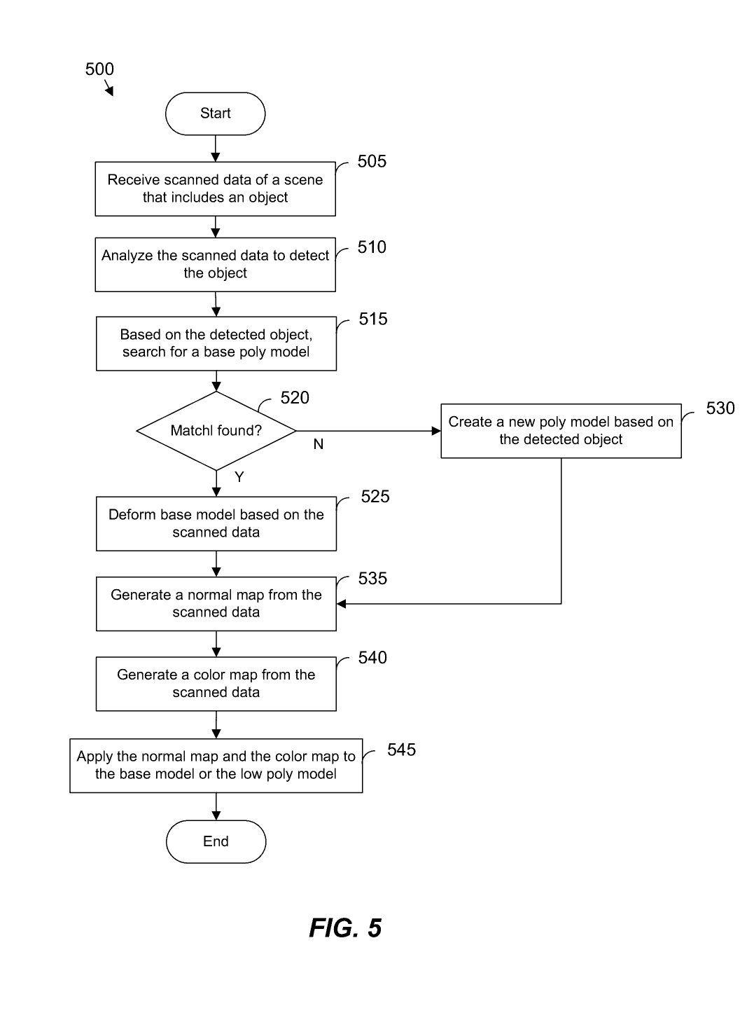

In some embodiments, the system performs a number of different operations to construct a 3D model. Several additional example operations will now be described by reference to FIGS. 5-9.

A. Deciding Whether to Use a Base Model or Generate a New Model

In several of the examples described above, the system uses a pre-defined base model to replicate an object or dynamically generates a new model. In some embodiments, if the scanned data appears close to a primitive or if the system knows the shape, it uses a base model to perform the retargeting operation. Otherwise, the system parametrically builds a new 3D model.

FIG. 5 conceptually illustrates an example process 500 that some embodiments perform to create a 3D model of an object. In some embodiments, the process 500 is performed by a reconstruction program that executes on a computing device.

As shown, the process 500 begins by receiving (at 505) scanned data of a scene that includes an object. The process 500 then analyzes (at 510) the data to detect the object in the scene. Based on the detected object, the process searches (at 515) for a base poly model. For instance, the process might choose one specific base model from a number of different base models in accord with the detected object.

The process determines (at 520) whether a match is found. If a match is found, the process 500 deforms (at 525) the base model to produce a representation of the object. However, if a match is not found, the process 500 creates (at 530) a new poly model based on the detected object.

As shown in FIG. 5, the process 500 extracts (at 535) a normal map from the scanned data. The process 500 extracts (at 540) a color map from the scanned data. Thereafter, the process 500 associates the normal map and the color map to the deformed base model or the new poly model. In some embodiments, the process 500 makes this association to define and store the new 3D model. The process 500 might also apply (at 545) the normal map and the color map to render and display the new 3D model. The process 500 then ends.

Some embodiments perform variations on the process 500. The specific operations of the process 500 may not be performed in the exact order shown and described. The specific operations may not be performed in one continuous series of operations, and different specific operations may be performed in different embodiments.

B. Filtering

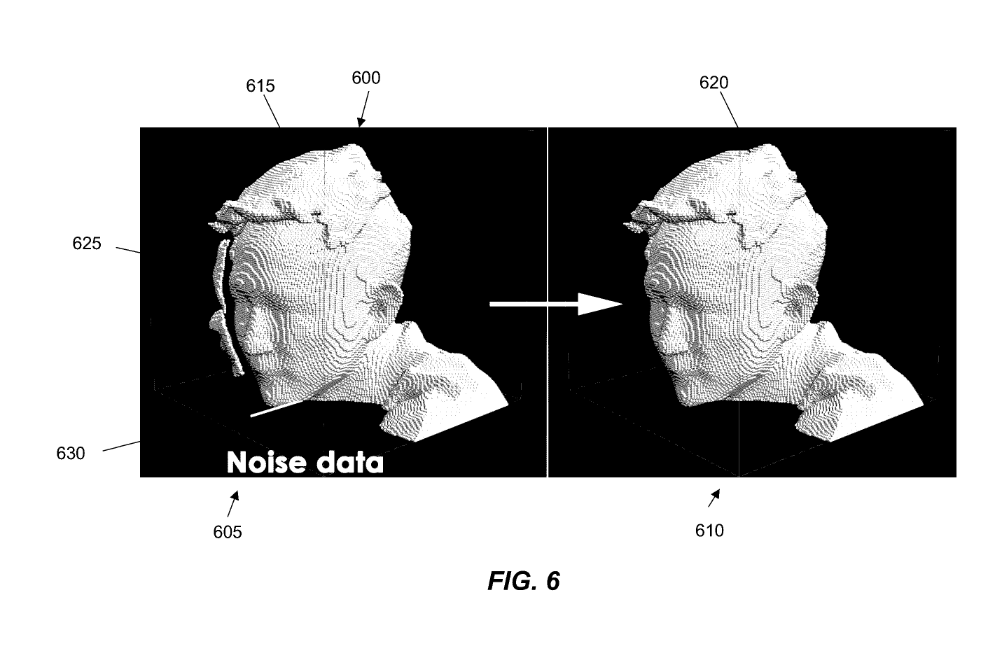

As mentioned above, the system of some embodiments performs a filtering operation. FIG. 6 provides an illustrative example of filtering captured data. Specifically, the figure shows in two stages 605 and 610 how the system's reconstruction program reviews the captured data 600 and eliminates noise data from the captured data. In some embodiments, the system filters data to capture a visual representation of the object. In conjunction with capturing a visual representation, or instead of it, the system of some embodiments filters data to capture a volumetric representation.

As shown in the first stage 605 of FIG. 6, the captured data 600 has noise data or artifacts. There are several reasons why such noise data is present in the captured data. As a first example, the object may have been in motion when it was captured with a particular device. As a second example, the capturing device could have been in motion. As a third example, the ambient light of the scene may have affected how the object was captured.

In some embodiments, the program performs one or more different filtering operations to filter out the noise data. The program of some embodiments filter out the noise data by identifying non-contiguous data points and eliminating them from captured data. For instance, in the first stage 605 of FIG. 6, a first group of polygons 625 that represents a portion of the human face is displaced from a second group of polygons 615 that represents the more-complete human face. Here, the program identifies the discontinuity of the data points on the outer edge of the human face and eliminates those data points from the captured data. The results of the filtering operation are shown in the second stage 610 where the first group of polygons 625 has been removed from the captured data.

In some embodiments, the program eliminates data points that are outside a given threshold range. For instance, in the first stage 605 of FIG. 6, a third group of polygons 630 that represents a lighting artifact is connected to the second group of polygons 615. However, the third group of polygons 630 is outside a given range relative to the second group of polygons 615. Thus, as shown in the second stage 615, the program has identified the third group of polygons 630 and removed it from the captured data.

In filtering, the program of some embodiments eliminates unwanted objects from captured data. For instance, if an object has been detected in a scene, the program may eliminate all other data relating other objects in that same scene. In some embodiments, the program performs multiple filtering operations at different stages. For instance, in the example of FIG. 6, the program filters the captured data. Instead of or in conjunction with filtering the captured data, the program of some embodiments filters the result data to eliminate abnormalities.

C. Reconstructing Incomplete Objects

The preceding sub-section described several example operations performed by the system to eliminate unwanted data. In some embodiments, the system fills in or reconstructs data. In reconstructing, the system uses one or more different methods.

FIG. 7 provides an illustrative example of reconstructing an incomplete object. Specifically, the figure shows in two stages 705 and 710 how the program of some embodiments processes a 3D model 715 to fill in missing data. In some embodiments, the system reconstructs data to capture a visual representation of the object.

In some embodiments, if the target object is a symmetrical and the captured data has data missing from one side, the program retrieves the missing data from the other side. For instance, in the first stage 705 of FIG. 7, the 3D model 715 is shown with incomplete data as one side of the 3D model is associated with incorrect data. This is because the captured data does not have enough data or have missing data to build a complete object.

The second stage 710 shows the 3D model 715 after it was processed by the program. To fill in the data on one side of the symmetrical object, the program has used data relating to the object's opposite side. In some embodiments, the program uses processed mesh data to fill in empty areas. That is, the program does not use raw data to reconstruct a 3D model of an object but uses polygon data that was produced using the raw data.

In some embodiments, the program retrieves data from a data store to reconstruct a 3D model. For instance, if the target isn't symmetrical but the system know what type of object it is, the system retrieves the missing data from a data store (e.g., database) to rebuild the 3D model. In some embodiments, if target object isn't symmetrical but the system has data relating to the same object, the system retrieves the missing data from a data store to rebuild the 3D model. Regardless of whether the object is symmetrical or not, the program of some embodiments retrieves data from a data store if the data is available.

In some embodiments, the program processes a set of images (e.g., photos) to rebuild an object. After finishing the full scan to capture the initial 3D model, if the program has access to any still shot on any direction/angle that contains both eyes, nose, and mouth, the program can rebuild full face in 3D.

The program of some embodiments assembles data with an array of input relating to multiple different people. This means that if the initial data has both eyes, the nose, and the mouth which has the only one direction of depth data, it can be combined with any direction of data that has both eyes, the nose, and the mouth to make one complete 3D data.

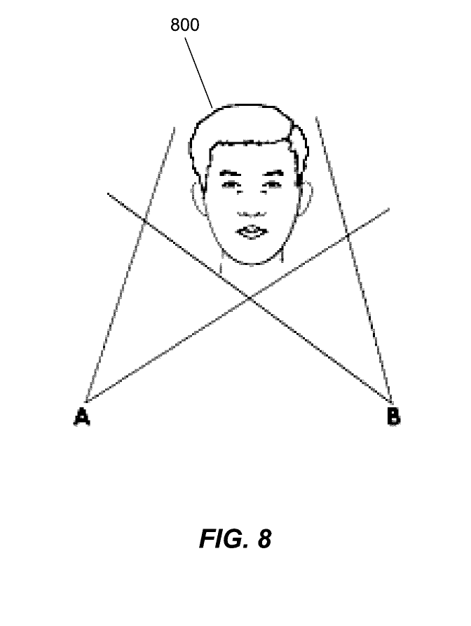

In some embodiments, the program combines images and/or depth information from multiple devices (e.g., with different angles) to sync together to create a target to build one unified 3D data. FIG. 8 conceptually illustrates an example of combining images from several devices to produce a 3D model. In particular, the figure shows several devices (A and B) that captures data of a human head 800 from different angles. The program of some embodiments combines the data (e.g., photos, captured depth) from the devices (A and B) to reconstruct an object.

In some embodiments, when the system captures or process 2D image data, it eliminates shadows from the image. In eliminating, the system of some embodiment fills in shaded areas with a set of other colors (e.g., skin tone colors) that are shown in an image. Removing the shadows is important because it allows the resulting 3D model to appear natural with artificial lighting. For instance, the system may provide user interface (UI) tools to add a set of one or more virtual 3D lights. This is to add 3D shadow(s) and/or direction of the light source(s).

D. Generating High-Poly Models

As mentioned above, the system of some embodiments takes a high-poly model and generates a low-poly model. In some such embodiments, the system also extracts a data map that has surface details. In some embodiments, the system uses the extracted data map to generate a high poly model from a low poly model.

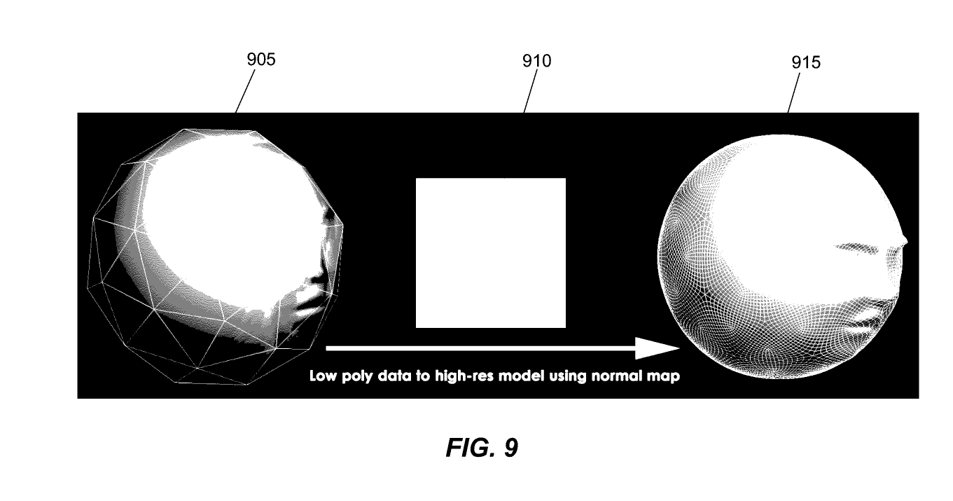

FIG. 9 shows an example of generating a high poly model from a low poly model. Specifically, the figure shows that the program uses a normal map 910 to generate a high poly model 915 from a low poly model 905. Here, the program analyzes the surface detail info from the normal map 910 and produces a new 3D model having additional polygons. In some embodiments, the program uses the surface data to produce several polygons from each polygon of the low polygon model 905.

### II. Using Visual Representations

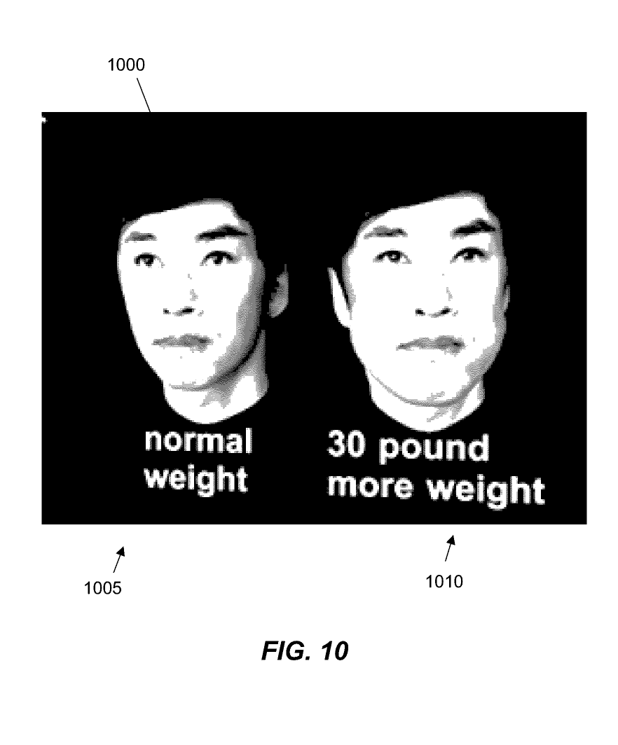

In some embodiments, the system provides a set of tools to modify a 3D model of an object. The system of some embodiments provides tools to forecast or predict how a person may appear at a give age. The system of some embodiments provides other tools to change the appearance of an object. For instance, the system may be used change the weight of a person, forecast weight changes, etc. Several such examples will now be described by reference to FIGS. 10-12.

A. Modifying Objects

In some embodiments, the system provides user interface tools to change features or characteristics of an object. In some embodiments, the tools are for customizing a human head or face. The human customization system can also include tools to change weight of a person or a part of the person (e.g., the head, face, etc.).

FIG. 10 shows an example modifying features of a human head. Specifically, it shows how a user interface (UI) of the system can be used to change weight of a human head. More specifically, the figure show a part of customization tool that the user can use to change the weight of person's face to visualize weight changes. In some embodiments, the UI can be used to generate or project different volume models.

Two stages 1005 and 1010 of operations are shown in FIG. 10. The first stage 1005 shows a 3D model 1000 of a person. The person is shown with normal weight. The second stage 1010 shows the altered 3D model 1000. Here, the model 1000 has been altered such that the person appears with additional weight (i.e., 30 pounds more weight).

In some embodiments, the program operates on visual data (e.g., polygon data, captured depth, color info) to generate different versions of a captured 3D model. The program may also use a set of one or more photos to generate different versions. In some embodiments, the projected volume model is generated based on input weight. For instance, to make the change, a system user might have entered the additional weight into the UI. The system has then processed the input to produce a projected volume model with high accuracy.

In some embodiments, the projected volume model is generated based on other data. For instance, the program of some embodiments can project, with two different sets of data for the same person at two different time periods, how the person will appear at a given time given time period. The next sub-section relating to 3D aging system provides additional details regarding such projections.

In some embodiments, the human head 3D customization system provides additional tools to change how a person appears. For instance, some embodiments provides UI widgets (e.g., buttons, sliders) and/or other selectable items (e.g., images) to change the hairstyle of a person, add or remove facial hair (e.g., a beard), etc. Further, it is to be understood that the object can be any object, animate or inanimate, or a portion thereof, and not only a human head.

B. 3D Aging System

In some embodiments, the system is used to forecast or predict how an object will appear at a given age. For instance, the forecast system can be used to make a person appear younger or older. This can be for a person's face, the entire head, the body, etc.

In some embodiments, if the system captures the same person at multiple different timeframes, it can build time-lapse data. With this data, it can build 3D facial aging data with its algorithm. For instance, if the system takes two scans over ten years time span, it can forecast before and after data in full 3D. Even if the system takes the facial scan of only two time periods, the system can rebuild 3D data with any given time or age to forecast their face. In generating, the system of some embodiments incorporates medical aging research data relating to a person to improve the final result.

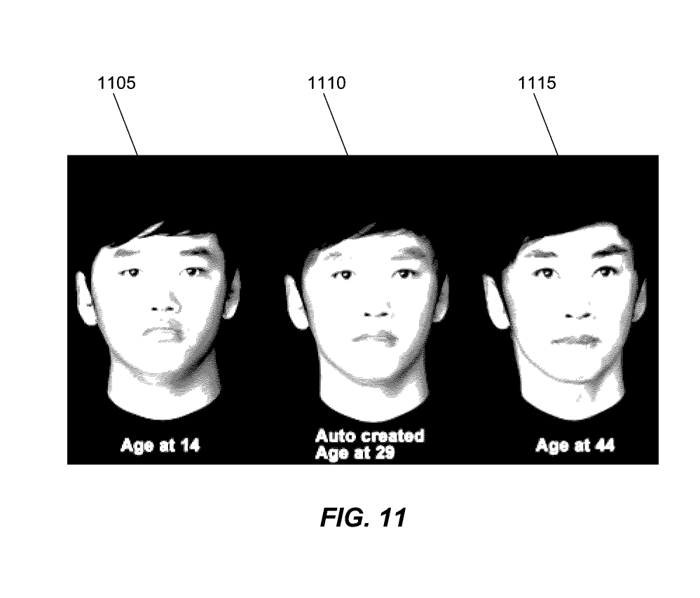

FIG. 11 conceptually illustrates operations performed by the aging forecast system to predict and show how a person will appear at a given age. The figure shows three 3D models 1105, 1110, and 1115. The first model 1105 was generated using a first set of captured 3D data of a person at a first timeframe, while the third model 1115 was generated using a second set of captured 3D data of the same person at a second timeframe. Specifically, the first timeframe was when the person was fourteen years old, and the second timeframe was when the person was forty four years old.

By contrast, the second model 1110 was auto-generated using the data associated with the first and third models 1105 and 1115. The system has taken the data associated with the two models 1105 and 1115 and created a new 3D model 1110 that shows the person at age twenty nine.

In some embodiments, the system generates a new model using one or more different techniques. For instance, in the example of FIG. 11, the system has predicted the size or volume of the person head at that particular age. The system has also predicted how the person's skin tone, hair, and various facial features (e.g., the eyes, the nose, the lips) may appear at that particular age. The program of some embodiments operates on visual data (e.g., polygon data, photos, captured depth) of two 3D models (e.g., of the same object at different time periods) to generated the new 3D model.

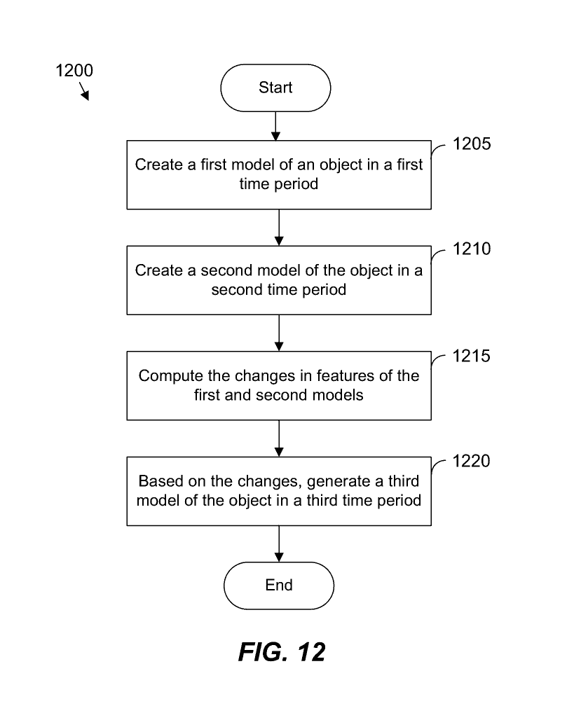

Having described several example operations, a process will now be described. FIG. 12 conceptually illustrates an example process 1200 that some embodiments perform to predict how an animate object will appear at a given age. In some embodiments, the process 1200 is performed by the system's forecast program that executes on a computing device.

As shown, the process 1200 begins (1205) by creating a first model of an object. The model is created using data that shows the object at a first time period. Several examples of creating models are described above by reference to FIGS. 1, 3, and 4. The process 1200 then creates (at 1210) a second model of the same object. The second model is created using data that shows the object at a second different time period.

As shown in FIG. 12, using the models' data, the process 1200 computes (at 1215) the changes in features of the first and second models. In computing, the process 1200 of some embodiments takes into account the medical history associated with a person.

The process 1200 then generates (at 1220) a third model of the same object. The third model is auto-generated based on the computed changes and depicts the object at a third time period. The process 1200 of some embodiments operates on visual data (e.g., polygon data, normal map, color map) of the two 3D models (e.g., of the same object at different time periods) to generated the new 3D model. The process 1200 may also use a set of one or more photos to generate the new 3D model. The process 1200 then ends.

Some embodiments perform variations on the process 1200. The specific operations of the process 1200 may not be performed in the exact order shown and described. The specific operations may not be performed in one continuous series of operations, and different specific operations may be performed in different embodiments.

### III. Full Facial Dimension (FFD) Identification System (FFDIS)

In some embodiments, the system captures volumetric data relating to an object from scanned data of an object. The volumetric data is then used to identify the object from a number of different objects. That is, the system of some embodiments provides tools to identify different objects based on their volume. In some embodiments, the system is a true 3D volumetric identification system in that uses signature volume data to compare and identify objects instead of the shapes.

There are several benefits to using the volume compare system of some embodiments. The system does not look at how the object appears (e.g., on screen) as a first priority. Rather, it recognizes an object based on its associated volume data. For instance, the benefit of this volume compare system is that it does not matter of the cosmetics that people wear or the skin complexion/shading on their face. The system recognizes the face by volume.

A. Capturing Volumetric Representations

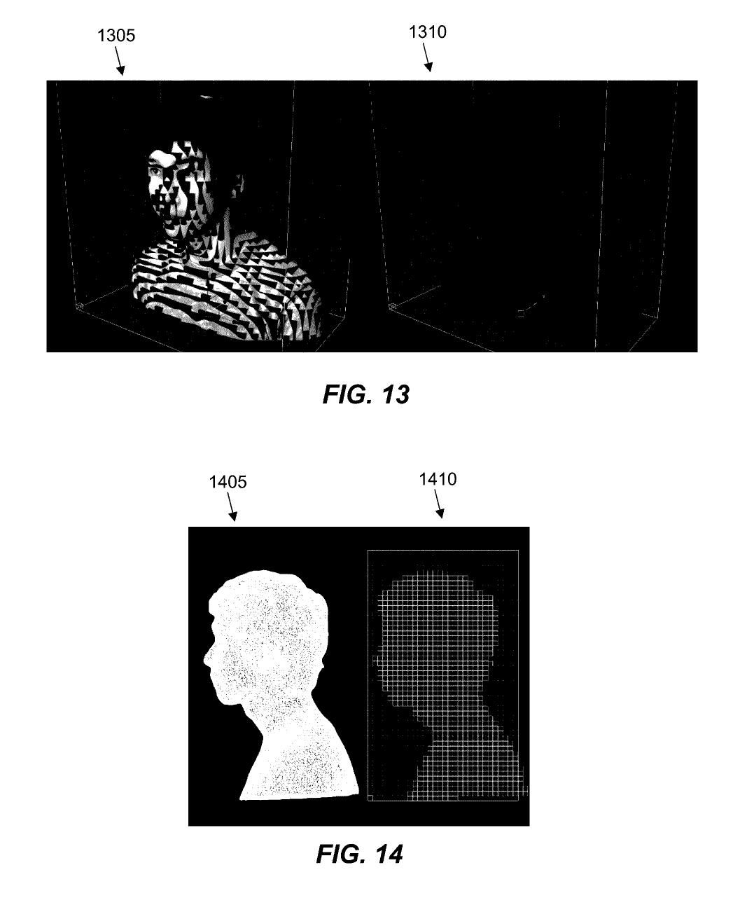

In some embodiments, the system captures a volumetric representation of an object from scanned data. FIG. 13 shows an example of creating volume data from scanned data of an object. As shown, the system reads the scanned data 1305 of the object to compute its volume data 1310. In some embodiments, the volume data is represented in voxel. This is conceptually shown with the number of boxes over the face of the scanned object 1305. A voxel is similar to a pixel in a bitmap image. However, the voxel is representative of 3D data. It describes a unit of graphic information that defines a point in a 3D space. The voxel may be described by reference to its position relative to other voxels.

The scan data may come with depth data. The depth data may include position data, photo image data, (e.g., maps, photos). In some embodiments, the system treats such depth data as a volume data instead of shape data. That is, the system produces voxel data out of volume data.

FIG. 14 shows an example of using volume data to generate a group of voxels. Specially, the figure shows an orthographic view of 3d voxel data 1410. The 3D voxel data 1410 is produced using the volume data 1405, and appears on the side view as a stack of cubes. The stack of cubes is also arranged in a grid-like manner. The voxel data 1410 is produced in order to speed up data comparison operations. Different from voxel data, the system of some embodiments uses polygonal data for fast data transfer and display.

In some embodiments, the system creates different level of resolutions of voxel data. That is, instead of comparing high resolution 3D mesh data that can take a very long time to process, the system produces different sets of voxel data. For instance, the system can start with low resolution level of voxel data to compare to filter out database. At the second stage, the system can generate mid-level of voxel data which takes more time to compare on each time but with much less number of lists to compare. The system can then use the mid-level voxel data to filter out narrow down the list.

B. Fast Search

In some embodiments, the system uses the fast voxel-based volume compare method. In some embodiments, the system compares facial features to identify a person. The system may compare volumetric data relating to the eyes, nose, mouth, and/or other features. As an example, a person can be correctly identified from many different people based on the volumetric data relating to the person's ear. In some embodiments, the person can also be identified using different combinations of facial features.

Alternatively or conjunctively with facial features, the system of some embodiments uses facial structure as a signature volume data to search a data store (e.g., a database). By signature, the system can take the volumetric data relating to the facial structure and use it as the basis of the compare operation. For instance, the system might try to find one or more people that have the same or similar structure data. If the system finds more than one person, the system might drill down and use one or more different facial feature data to identify the person. In some embodiments, the system uses volumetric data as well as other data to identify an object. For instance, the system may use signature voice data as ID. As such the system of some embodiments examines not only 3D volume data but also other data (e.g., biometric data).

In some embodiments, all of the 3D models that are processed with the system have the physically accurate size and length information unlike a 2D picture. This can result in much faster and accurate database search.

As mentioned above, the system of some embodiments creates different resolutions of voxel data. This is because comparing 3D mesh takes very long time to process. By taking the different resolution of voxel data, the system of some embodiments performs a multi-level comparison in order to find a matching object.

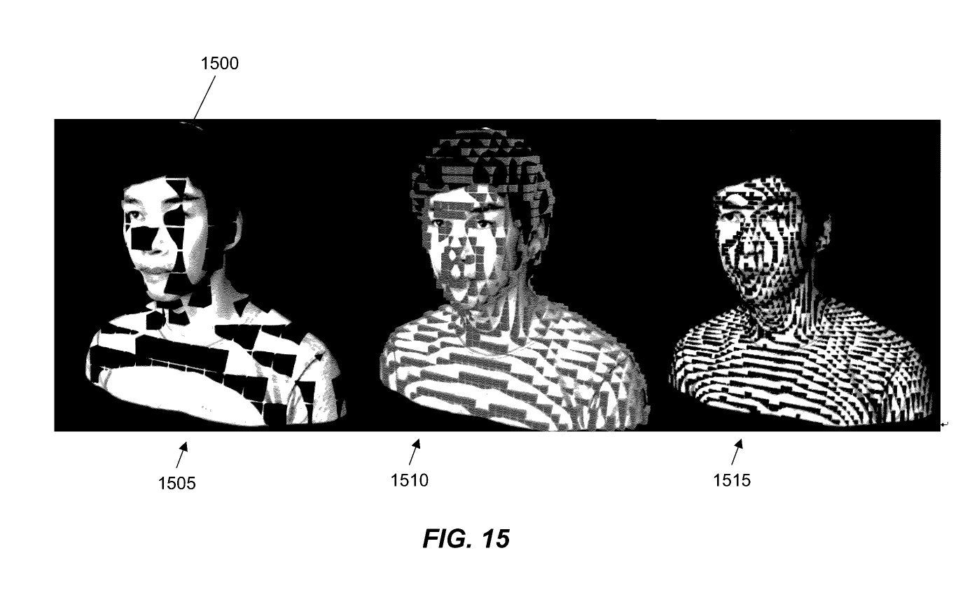

FIG. 15 conceptually shows an example of a multi-level volumetric search to identify a person. Three stages 1505-1515 of operations of the system are shown in the figure. A three-level search is shown in the figure. However, the search can have additional levels or even fewer levels. The search can be based on one facial feature or a combination of different facial features (e.g., face structure, eyes, nose, mouth, etc.).

In the first stage 1505, the system analyzes a first set of low resolution volume data relating to a person 1500. Based on the match in the first stage 1505, the second stage 1510 shows the system analyzing a second set of medium resolution volume data relating to the same person. Based on the match in the second stage 1510, the third stage 1515 shows the system analyzing a third set of higher resolution volume data relating to the same person.

In some embodiments, the system can be used to find a missing person with old facial data. For instance, if the system only has one scanned data of a missing child who has been missing for a long time, the system can also use the parents' facial characteristic data to forecast his/her face.

In the first stage 1505, the system creates and compares with the database using a first set low resolution volume data relating to a person 1500. Based on the match in the first stage 1505, the second stage 1510 shows the system analyzing the match using a second set of medium resolution volume data relating to the same person. Based on the match in the second stage 1510, the third stage 1515 shows the system analyzing the match using a third set of higher resolution volume data relating to the same person.

### IV. Example Systems

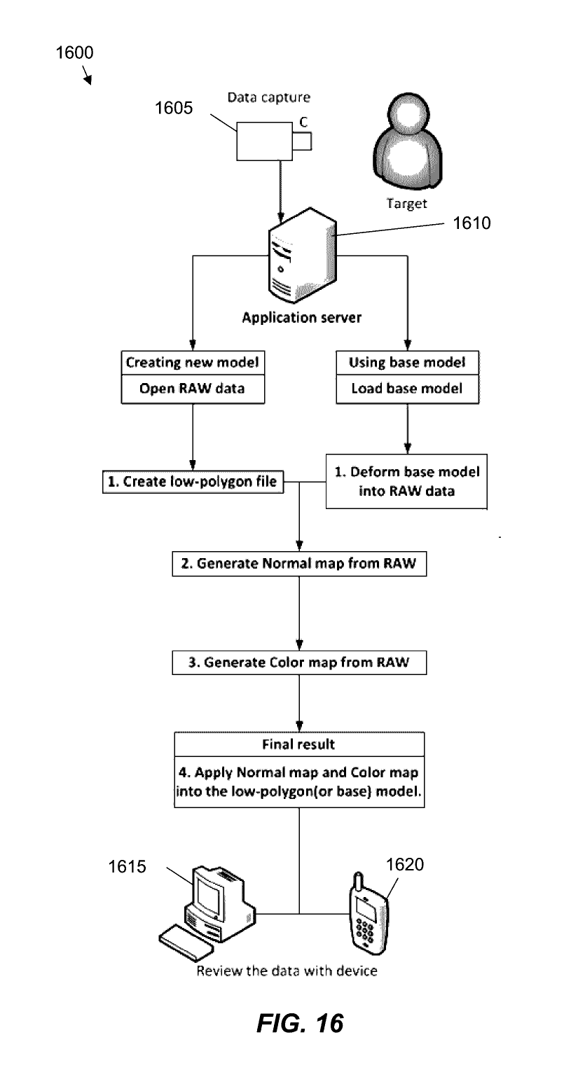

Several example systems will now be described below by reference to FIGS. 16-18. In some embodiments, the system is provided as a thick client. That is, the system's program runs on the client machine. In some other embodiments, the program is provided as part of a server-based solution. In some such embodiments, the program may be provided via a thin client. That is, the program runs on a server while a user interacts with the program via a separate machine remote from the server.

FIG. 16 illustrates an example system 1600 that captures and presents 3D models. Here, the system is a distributed one, which means that the processing is performed on the server and not on the client. However, as mentioned above, the processing may be performed on a client device, in some embodiments.

FIG. 16 shows a data capture device 1605, an application server 1610, and several computing devices 1615 and 1620. In the illustrated example, the data capture device 1605 captures data of a target object. As mentioned above, the data may originate from one or more different data sources. The data might have been captured with a set of one or more cameras. The data might have been captured with a computing device having a depth sensor and a camera. The data might have been captured with an input device that is communicatively coupled or connected to a computing device.

After capturing the data, the data capture device 1605 sends the data to the application server 1610. The application server 1610 then performs a process to generate a 3D model of the target object. In this example, the application server either deforms a base model or produces a new model. This is the same process as the one described above by reference to FIG. 5. After processing the data, the application server may store the results in a data store (e.g., a storage server). The application server may store the original captured data along with the result data.

As shown in FIG. 16, the final result (e.g., the new low poly model, the deformed based model) is sent to a set of one or more computing devices 1615 and 1620. The set of computing devices 1615 and 1620 then renders the result data in order to present the 3D model of the target object. One of the set of computing devices 1615 and 1620 may be the same as the data capture device 1605. Once the system makes the 3D model data, people can review and search the 3D models that are securely encrypted on portable devices, in some embodiments.

In the example described above, the processing of the captured data is off-loaded to the application server 1610. This is particularly useful for client devices (e.g., smart phones, tablets) that do not have the hardware specifications to efficiently process the captured data. On the other hand, for some other devices (e.g., a desktop computer), it may be more efficient to process the captured data locally. Also, the client machine does not have to send large chunks of data to the application server for processing.

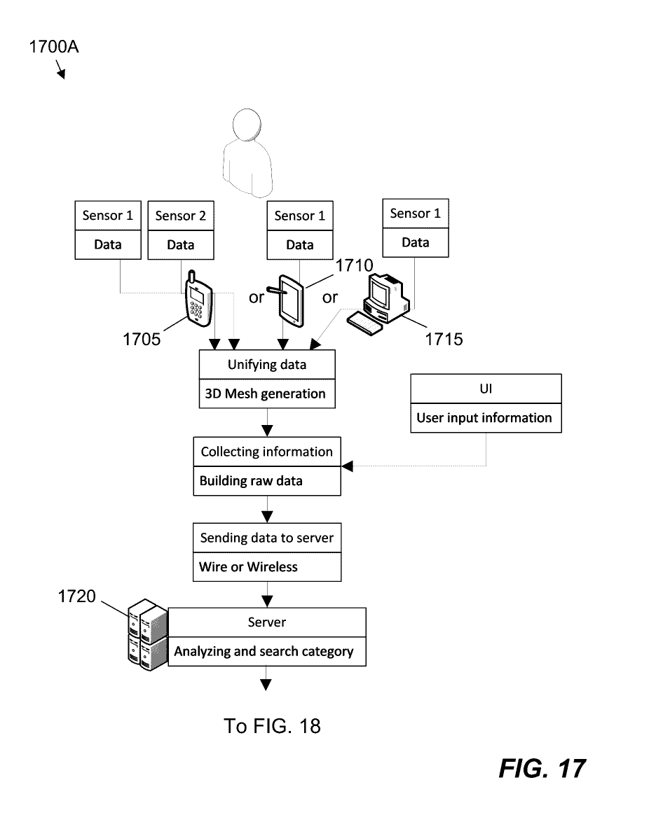

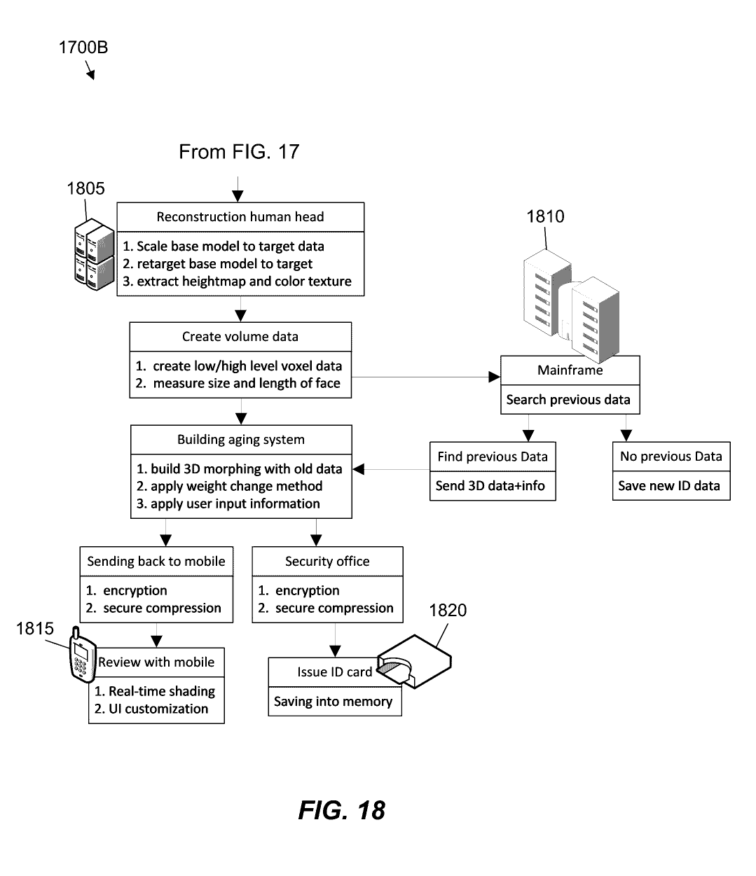

In some embodiments, the captured data is used for a 3D identification system. FIGS. 17 and 18 show an example system 1700 to use the captured 3D data to facial recognition and provide 3D models from captured data. As shown in these FIGs., the system 1700 includes a set of computing devices 1705-1715 (e.g., mobile device, PDA, desktop computer), a set of server 1720 and 1805, and a set of data servers or mainframes 1810.

In some embodiments, each of these devices 1705, 1710, or 1715 can capture data (e.g., build raw data with one or more depth sensors); generate 3D mesh data; and send data to a server in the set of servers.

FIG. 16 shows that each server 1720 or 1805 in the set of servers can perform various task related to facial identification. The tasks may be performed by a number of servers or just one server, in some embodiments. The server of some embodiments analyzes captured data and categorizes data. The server of some embodiments can search different categories relating to a person. In some embodiments, the server has a set of programs to scale base model to target data, retarget base model to target, and extract heightmap and color texture. In some embodiments, the set of servers creates various different levels of voxel data. In some embodiments, the voxel data is volumetric data that is derived from the scanned data. In some embodiments, the voxel data is used for facial identification or person identification.

In some embodiments, the set of servers provides a 3D aging system. The 3D aging system can build 3D morphed data by combining different data, such as existing data with new data or forecast data. In some embodiments, the set of servers applies weight methodology. The set of server may alter the model by applying user input data.

In some embodiments, the set of servers store data with one or more storage servers 1810 in one or more data centers (e.g., mainframe). The user can also review the (e.g., encrypted) data from the set of servers on the user's mobile device 1815. In some embodiments, the user can access the encrypted data using an issued ID card from a security system or office. The ID card can be used in conjunction with a card reader 1820. In some embodiments, the security is handled differently. For instance, the security can be handled through biometric data (e.g., fingerprint), pass code (e.g., password), etc. To verify a person's identify, the system of some embodiments performs a number of different verification methods (e.g., card and pass code).

It is to be understood that the systems shown in FIGS. 16-18 are example system and different embodiments may use the different resolution captured data differently. For instance, in the example system 1700, the server computer performs various tasks, including creating 3D models and performing facial or person identification. In some embolisms, such operations are not performed on server computers but on client devices. Also, severer tasks that are shown as being performed by one device or one server can potentially be distributed amongst servers in a server cloud.

### IV. Electronic Systems

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

A. Computer System

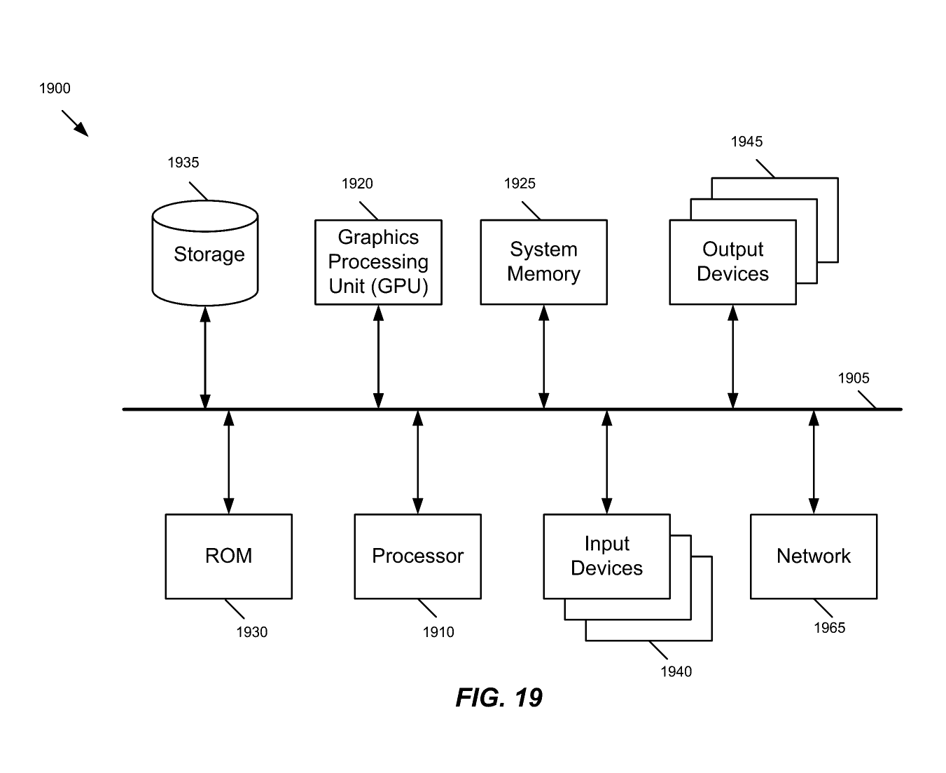

In some embodiment, one or more of the system's programs operate on a computer system. FIG. 19 conceptually illustrates an electronic system 1900 with which some embodiments of the invention are implemented. The electronic system 1900 may be a computer (e.g., a desktop computer, personal computer, tablet computer, etc.), server, dedicated switch, phone, PDA, or any other sort of electronic or computing device. Such an electronic system includes various types of computer readable media and interfaces for various other types of computer readable media. Electronic system 1900 includes a bus 1905, processing unit(s) 1910, a system memory 1925, a read-only memory 1930, a permanent storage device 1935, input devices 1940, and output devices 1945.

The bus 1905 collectively represents all system, peripheral, and chipset buses that communicatively connect the numerous internal devices of the electronic system 1900. For instance, the bus 1905 communicatively connects the processing unit(s) 1910 with the read-only memory 1930, the system memory 1925, and the permanent storage device 1935.

From these various memory units, the processing unit(s) 1910 retrieves instructions to execute and data to process in order to execute the processes of the invention. The processing unit(s) may be a single processor or a multi-core processor in different embodiments.

The read-only-memory (ROM) 1930 stores static data and instructions that are needed by the processing unit(s) 1910 and other modules of the electronic system. The permanent storage device 1935, on the other hand, is a read-and-write memory device. This device is a non-volatile memory unit that stores instructions and data even when the electronic system 1900 is off. Some embodiments of the invention use a mass-storage device (such as a magnetic or optical disk and its corresponding disk drive) as the permanent storage device 1935.

Other embodiments use a removable storage device (such as a floppy disk, flash memory device, etc., and its corresponding drive) as the permanent storage device. Like the permanent storage device 1935, the system memory 1925 is a read-and-write memory device. However, unlike storage device 1935, the system memory 1925 is a volatile read-and-write memory, such a random access memory. The system memory 1925 stores some of the instructions and data that the processor needs at runtime. In some embodiments, the invention's processes are stored in the system memory 1925, the permanent storage device 1935, and/or the read-only memory 1930. From these various memory units, the processing unit(s) 1910 retrieves instructions to execute and data to process in order to execute the processes of some embodiments.

The bus 1905 also connects to the input and output devices 1940 and 1945. The input devices 1940 enable the user to communicate information and select commands to the electronic system. The input devices 1940 include alphanumeric keyboards and pointing devices (also called “cursor control devices”), cameras (e.g., webcams), microphones or similar devices for receiving voice commands, etc. The output devices 1945 display images generated by the electronic system or otherwise output data. The output devices 1945 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 19, bus 1905 also couples electronic system 1900 to a network 1965 through a network adapter (not shown). In this manner, the computer can be a part of a network of computers (such as a local area network (“LAN”), a wide area network (“WAN”), or an Intranet, or a network of networks, such as the Internet. Any or all components of electronic system 1900 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

B. Mobile Device

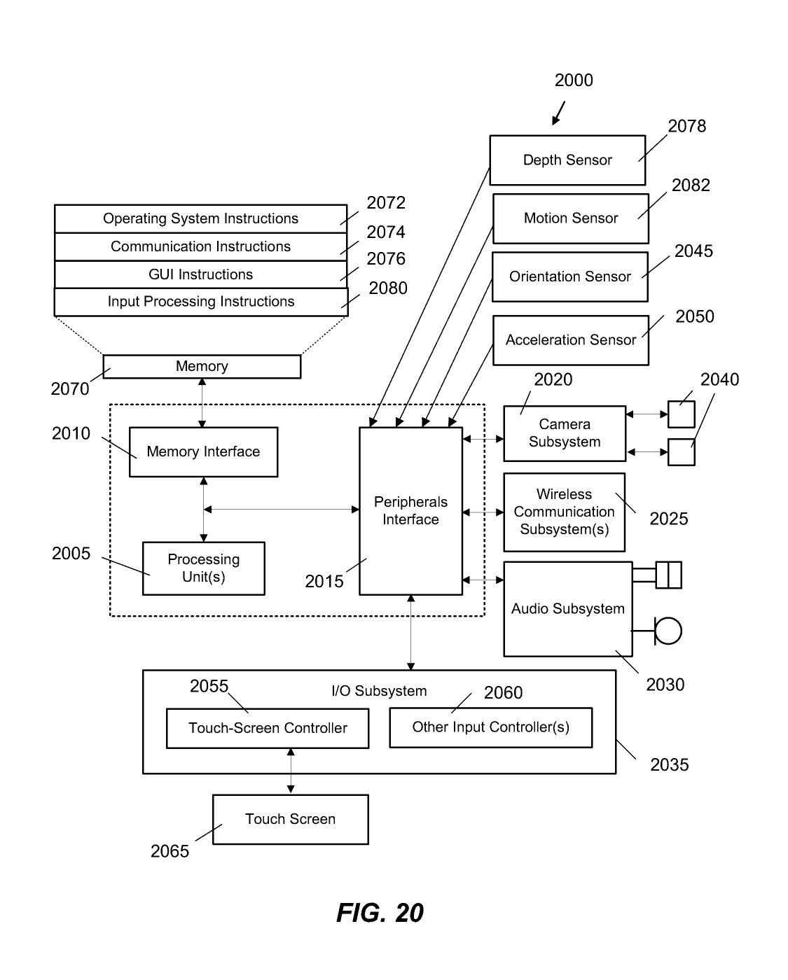

In some embodiment, one or more of the system's programs operate on a mobile device. FIG. 20 shows an example of an architecture 2000 of such a mobile computing device. Examples of mobile computing devices include smartphones, tablets, laptops, etc. The mobile computing device is also a capturing device, in some embodiments. As shown, the mobile computing device 2000 includes one or more processing units 2005, a memory interface 2010 and a peripherals interface 2015.

The peripherals interface 2015 is coupled to various sensors and subsystems, including a camera subsystem 2020, a wireless communication subsystem(s) 2025, an audio subsystem 2030, an I/O subsystem 2035, etc. The peripherals interface 2015 enables communication between the processing units 2005 and various peripherals. For instance, the depth sensor 2078 is coupled to the peripherals interface 2015 to facilitate depth capturing operations. The depth sensor 2078 may be used with the camera subsystem 2020 to capture 3D data. Also, for instance, the motion sensor 2082 is coupled to the peripherals interface 2015 to facilitate motion sensing operations. Further, for instance, an orientation sensor 2045 (e.g., a gyroscope) and an acceleration sensor 2050 (e.g., an accelerometer) is coupled to the peripherals interface 2015 to facilitate orientation and acceleration functions.

The camera subsystem 2020 is coupled to one or more optical sensors 2040 (e.g., a charged coupled device (CCD) optical sensor, a complementary metal-oxide-semiconductor (CMOS) optical sensor, etc.). The camera subsystem 2020 coupled with the optical sensors 2040 facilitates camera functions, such as image and/or video data capturing. As indicated above, the camera subsystem 2020 may work in conjunction with the depth sensor 2078 to capture 2078 to capture 3D data. The camera subsystem 2020 may be used with some other sensor(s) (e.g., with the motion sensor 2082) to estimate depth.

The wireless communication subsystem 2025 serves to facilitate communication functions. In some embodiments, the wireless communication subsystem 2025 includes radio frequency receivers and transmitters, and optical receivers and transmitters (not shown in FIG. 20). These receivers and transmitters are implemented to operate over one or more communication networks such as a LTE network, a Wi-Fi network, a Bluetooth network, etc. The audio subsystem 2030 is coupled to a speaker to output audio (e.g., to output different sound effects associated with different image operations). Additionally, the audio subsystem 2030 is coupled to a microphone to facilitate voice-enabled functions, such as voice recognition, digital recording, etc.

The I/O subsystem 2035 involves the transfer between input/output peripheral devices, such as a display, a touch screen, etc., and the data bus of the processing units 2005 through the peripherals interface 2015. The I/O subsystem 2035 includes a touch-screen controller 2055 and other input controllers 2060 to facilitate the transfer between input/output peripheral devices and the data bus of the processing units 2005. As shown, the touch-screen controller 2055 is coupled to a touch screen 2065. The touch-screen controller 2055 detects contact and movement on the touch screen 2065 using any of multiple touch sensitivity technologies. The other input controllers 2060 are coupled to other input/control devices, such as one or more buttons. Some embodiments include a near-touch sensitive screen and a corresponding controller that can detect near-touch interactions instead of or in addition to touch interactions.

The memory interface 2010 is coupled to memory 2070. In some embodiments, the memory 2070 includes volatile memory (e.g., high-speed random access memory), non-volatile memory (e.g., flash memory), a combination of volatile and non-volatile memory, and/or any other type of memory. As illustrated in FIG. 20, the memory 2070 stores an operating system (OS) 2072. The OS 2072 includes instructions for handling basic system services and for performing hardware dependent tasks.

The memory 2070 may include communication instructions 2074 to facilitate communicating with one or more additional devices; graphical user interface instructions 2076 to facilitate graphic user interface processing; input processing instructions 2080 to facilitate input-related (e.g., touch input) processes and functions. The instructions described above are merely exemplary and the memory 2070 includes additional and/or other instructions in some embodiments. For instance, the memory for a smart phone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 20 are shown as separate components, it is to be understood that two or more components may be integrated into one or more integrated circuits. In addition, two or more components may be coupled together by one or more communication buses or signal lines. Also, while many of the functions have been described as being performed by one component, it is to be understood that the functions described with respect to FIG. 20 may be split into two or more integrated circuits.

While the invention has been described with reference to numerous specific details, it is to be understood that the invention can be embodied in other specific forms without departing from the spirit of the invention. In addition, a number of the figures (including FIGS. 2, 4, 5, and 12) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, it is to be understood that the invention is not to be limited by the foregoing illustrative details, but rather is to be defined by the appended claims.

What is claimed is:

1. A non-transitory machine readable medium storing a program for reconstructing an object, the program comprising sets of instructions for:
receiving captured data of a scene that includes the object;
analyzing the scanned data to detect the object;
from a number of different base models, selecting a base model in accordance with the detected object; and
based on the captured data, deforming the base model to produce a 3D representation of the object in the scene.

2. The non-transitory machine readable medium of claim 1, wherein program further includes sets of instructions for identifying the object and selecting a particular base model based on the identification.

3. The non-transitory machine readable medium of claim 2, wherein program further includes a set of instructions for creating a new 3D model upon failure to identify the object.

4. The non-transitory machine readable medium of claim 1, wherein the program further comprises a set of instructions for extracting depth information from the scanned data in order to display the 3D model as having depth.

5. The non-transitory machine readable medium of claim 1, wherein the program further comprises a set of instructions for extracting color information from the scanned data in order to display the 3D model with color.

6. The non-transitory machine readable medium of claim 1, wherein the program further comprises a set of instructions for filtering the captured data to remove unwanted data.

7. The non-transitory machine readable medium of claim 1, wherein the program further comprises a set of instructions for reconstructing a part of the 3D representation.

8. The non-transitory machine readable medium of claim 1, wherein the program further comprises a set of instructions for providing a set of tools to change the shape of a feature of the 3D model.

9. The non-transitory machine readable medium of claim 1, wherein the object in the scene is a part of person or a person.

10. A method of reconstructing an object, the method comprising:
receiving captured data of a scene that includes the object;
analyzing the scanned data to detect the object;
from a number of different base models, selecting a base model in accordance with the detected object; and
based on the captured data, deforming the base model to produce a 3D representation of the object in the scene.

11. The method of claim 10 further comprising:
identifying the object; and
selecting a particular base model based on the identification.

12. The method of claim 11 further comprising creating a new 3D model upon failure to identify the object.

13. The method of claim 10 further comprising saving a set of depth maps associated with the scanned data in order to display a high-resolution version of the 3D model of the object.

14. The method of claim 10 further comprising saving at least one of a set color maps and a set of photos associated with the scanned data in order to display the 3D model.

15. The method of claim 10 further comprising filtering the captured data to remove unwanted data, wherein the filtering comprises identifying discontinuity of data points on the outer edge of the object and eliminating the data points from the captured data.

16. The method of claim 10 further comprising filtering the captured data to remove unwanted data, wherein the filtering comprises eliminating data points that are outside a given threshold range of the object.

17. The method of claim 10 further comprising identifying an abnormality in the 3D model and using object symmetry to reconstruct a part of the 3D model.

18. The method of claim 10 further comprising:
receiving a user input to change the shape of a feature of the 3D model; and
modifying the 3D model in accord with the input.

19. A system comprising:
a capturing device having a set of one or more cameras and a set of sensors to capture data relating to an object; and
a computing device having a set of processors and a set of storages that stores a program having sets of instructions for execution by the set of processors, including:
receiving captured data of a scene that includes the object;
analyzing the scanned data to detect the object;
from a number of different base models, selecting a base model in accordance with the detected object; and
based on the captured data, deforming the base model to produce a 3D representation of the object in the scene.

20. The system of claim 19, wherein the program that is executing on the computing device has a set of instructions for identifying the object and selecting a particular base model based on the identification.
